(19) United States
(12) Patent Application Publication
(10) Pub. No.: US 2024/0355272 A1
(43) Pub. Date: Oct. 24, 2024

(54) LIGHT EMITTING DEVICE AND CONTROL SYSTEM FOR THE SAME

(71) Applicant: ANAX TECHNOLOGY CORP., Zhubei City (TW)

(72) Inventors: Li-Lun CHI, Zhubei City (TW); Chih-Chang WEI, Zhubei City (TW); Jyun-Long LIN, Zhubei City (TW); Ping-Yuan LIN, Zhubei City (TW); Yung-Ting CHEN, Zhubei City (TW)

(73) Assignee: ANAX TECHNOLOGY CORP., Zhubei City (TW)

(21) Appl. No.: 18/639,685

(22) Filed: Apr. 18, 2024

(30) Foreign Application Priority Data
Apr. 21, 2023 (TW) 112115024

(51) Int. Cl. G09G 3/32; H05B 45/14; H05B 45/44

(52) U.S. Cl. CPC G09G 3/32; H05B 45/14; H05B 45/44; G09G 2320/0626; G09G 2370/10

(57) ABSTRACT

A control system for a light emitting device is provided. The control system includes a control circuit, a common transmission line and a drive circuit string. The control circuit includes a control terminal. The drive circuit string includes N number of drive circuits, where N≥2. The drive circuit string is electrically connected to the control terminal of the control circuit through the common transmission line. Each of the drive circuits has a state setting. The state setting is in a transmission state when a setting of an assigned address of the drive circuit is completed. The control terminal transmits a command signal to each of the drive circuits via the common transmission line. The drive circuits read a command data piece or command data pieces within the command signal based on the assigned address.

### CROSS-REFERENCE TO RELATED APPLICATION

This application claims priority to Taiwanese Invention patent application No. 112115024, filed on Apr. 21, 2023, the entire disclosure of which is incorporated by reference herein.

### FIELD

The disclosure relates to a light emitting device, and a control system for the same.

### BACKGROUND

Referring to FIG. 1, a conventional control system for a light emitting device (e.g., a light emitting diode (LED) display) includes a control circuit (C1) and N number of drive circuits (D1 to DN), where N≥2. The control circuit (C1) includes a brightness control (or dimming control) terminal (DIM) for transmitting a brightness control signal and an address setting terminal (ADD) for transmitting an address setting signal. Each of the drive circuits (D1 to DN) includes a brightness control receiving terminal (DIP), an address setting receiving terminal (DIS), and an output terminal (DOS). The address setting receiving terminal (DIS) of the drive circuit (D1) is electrically connected to the address setting terminal (ADD) of the control circuit (C1) for receiving the address setting signal therefrom. The drive circuit (D1) generates an address data packet after processing the address setting signal, and transmits the address data packet from the output terminal (DOS) thereof to the address setting receiving terminal (DIS) of the drive circuit (D2). The drive circuit (D2) subsequently processes the address data packet and generates another address data packet to be transmitted to the drive circuit (D3). This process of processing the received address data packet, generating another address data packet and transmitting the generated address data packet to a next one of the drive circuit (D1 to DN) continues until the address setting receiving terminal (DIS) of the last drive circuit (DN) receives an address data packet. The brightness control receiving terminal (DIP) of each of the drive circuits (D1 to DN) is electrically connected to the brightness control terminal (DIM) of the control circuit (C1) for receiving the brightness control signal therefrom.

One of the disadvantages of the conventional control system is that the address setting signal and the brightness control signal are transmitted through different transmission lines. Furthermore, the conventional control system requires N number of wires (L1 to LN) that are respectively connected to the terminals (DIP) of the drive circuits (D1 to DN) for transmitting the brightness control signal to each of the drive circuits (D1 to DN), which increases wiring complexity.

### SUMMARY

Therefore, an object of the disclosure is to provide a control system for a light emitting device that can alleviate at least one of the drawbacks of the prior art.

According to a first aspect of the disclosure, the control system for a light emitting device includes a control circuit, a common transmission line, and a drive circuit string. The control circuit includes a control terminal.

The drive circuit string is electrically connected to the control terminal of the control circuit and includes N number of drive circuits, where N≥2. Each of the N number of drive circuits includes an input terminal and an output terminal. The input terminal of a first one of the N number of drive circuits is electrically connected to the control terminal of the control circuit via the common transmission line. The input terminal of an i^{th} one of the N number of drive circuits is electrically connected to the output terminal of an (i−1)^{th} one of the N number of drive circuits, where 2≤i≤N. The control terminal of the control circuit is configured to transmit an address setting signal to the drive circuit string via the common transmission line. The address setting signal includes a preset starting address. The N number of drive circuits are configured to sequentially set an assigned address for each of the N number of drive circuits based on the address setting signal.

The control terminal of the control circuit is configured to, after the setting of the assigned address of each of the N number of drive circuits is completed, transmit a command signal to each of the N number of drive circuits via the common transmission line. The command signal includes a data packet. The data packet includes X number of data piece(s) that correspond respectively to X number of destination address(es), where 1≤X≤N. The N number of drive circuits are configured in such a way that, based on the assigned addresses of the N number of drive circuits, among the N number of drive circuits, X number of drive circuit(s) of which the assigned address(es) respectively conform(s) with the destination address(es) read(s) the data piece(s).

According to a second aspect of the disclosure, the light emitting device includes N number of light emitting diode (LED) groups, and a control system that includes a control circuit and a drive circuit string. The control circuit includes a control terminal. The drive circuit string is electrically connected to the control terminal of the control circuit and includes N number of drive circuits, where N≥2. Each of the N number of drive circuits includes an input terminal and an output terminal. The input terminal of a first one of the N number of drive circuits is electrically connected to the control terminal. The input terminal of an i^{th} one of the N number of drive circuits is electrically connected to the output terminal of an (i−1)^{th} one of the N number of drive circuits, where 2≤i≤N.

The control terminal of the control circuit is configured to transmit an address setting signal to the drive circuit string. The address setting signal includes a preset starting address. The N number of drive circuits is configured to sequentially set an assigned address for each of the N number of drive circuits based on the address setting signal. Each of the N number of drive circuits has a state setting operable to switch between a transmission state and a non-transmission state with respect to signal transmission between the input terminal and the output terminal thereof. For each of the N number of drive circuits, when setting of the assigned address of the drive circuit is completed, the state setting of the drive circuit is in the transmission state. The control terminal of the control circuit is configured to, after the setting of the assigned address of each of the N number of drive circuits is completed, transmit a command signal to each of the N number of drive circuits. The command signal includes a data packet. The data packet includes X number of data piece(s) that correspond respectively to X number of destination address(es), where 1≤X≤N. The N number of drive circuits are configured in such a way that, based on the assigned addresses of the N number of drive circuits, among the N number of drive circuits, X number of drive circuit(s) of which the assigned address(es) respectively conform(s) with the destination address(es) read(s) the data piece(s). The N number of LED groups are respectively connected to and controlled by the N number of drive circuits to emit light.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a conventional light emitting device control system.

FIG. 2 is a block diagram illustrating a light emitting device according to an embodiment of the present disclosure.

FIG. 3 is a block diagram illustrating a drive circuit according to an embodiment of the present disclosure.

FIG. 4 is a diagram illustrating a packet format of an address setting data packet.

FIG. 5 is a timing diagram illustrating an address setting signal and serial address output signals outputted by a control circuit and drive circuits according to an embodiment of the present disclosure.

FIG. 6 is a timing diagram illustrating enabling signals outputted by decoder units of the drive circuits according to an embodiment of the present disclosure.

FIG. 7 is a circuit diagram of a data transmission unit according to an embodiment of the present disclosure.

FIG. 8 is a circuit diagram of a variation of the data transmission unit according to an embodiment of the present disclosure.

FIG. 9 is a circuit diagram of another variation of the data transmission unit according to an embodiment of the present disclosure.

FIG. 10 is a block diagram illustrating a pass-through signal transmission path according to an embodiment of the present disclosure.

FIG. 11 is a timing diagram illustrating transmission of brightness control signals through the drive circuits according to an embodiment of the present disclosure.

FIG. 12 is a diagram illustrating a packet format of a brightness data packet.

FIG. 13 is a timing diagram illustrating a status response signal according to an embodiment of the present disclosure.

FIG. 14 a circuit diagram of another variation of the data transmission unit according to an embodiment of the present disclosure.

FIG. 15 is a diagram illustrating packet formats of a data fetch request data packet and a response data packet according to an embodiment of the present disclosure.

FIG. 16 is a timing diagram illustrating transmission of the response data packet according to an embodiment of the present disclosure.

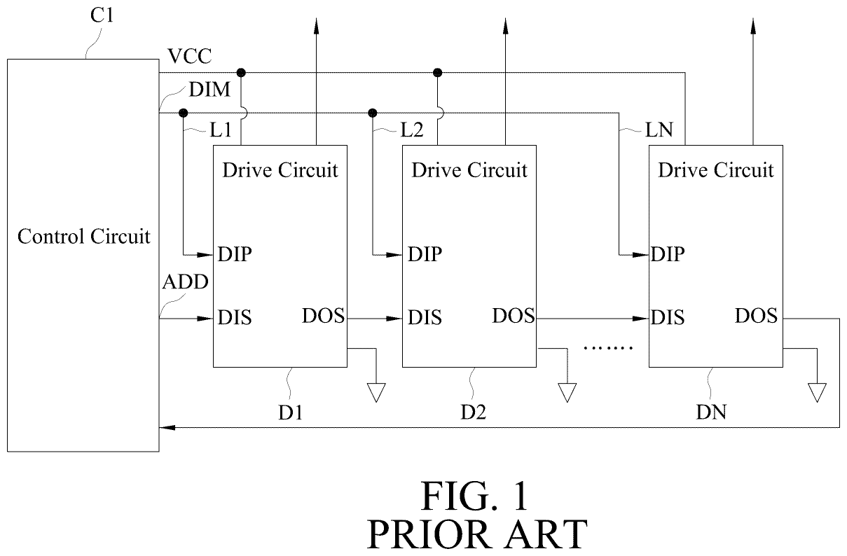

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

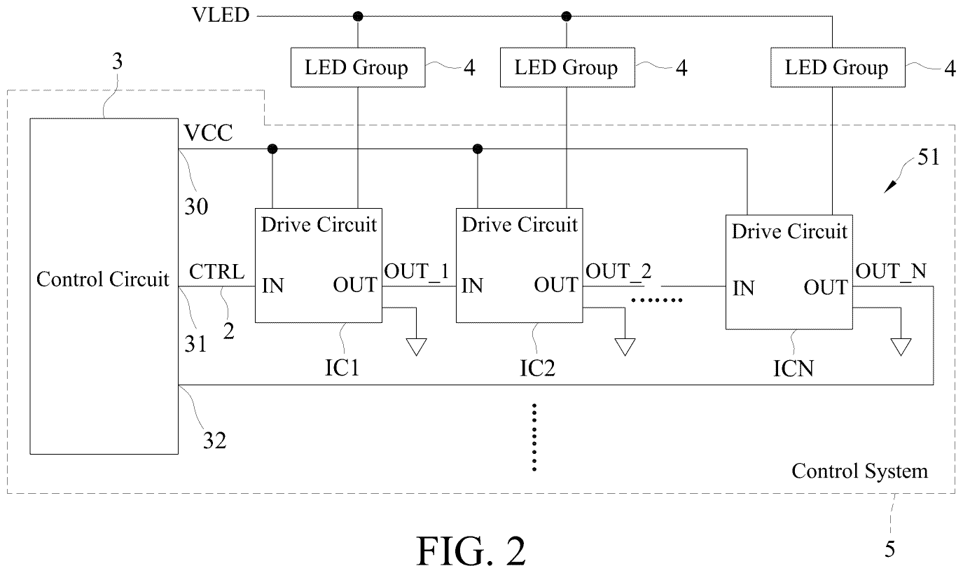

Referring to FIG. 2, a light emitting device according to an embodiment of the present disclosure is exemplified as a light emitting diode (LED) display, and includes N number of LED groups 4 and a control system 5 that is electrically connected to the LED groups 4, where N≥2. The LED groups 4 are disposed to receive a voltage (VLED) from a power supply (not shown).

The control system 5 includes a common transmission line 2, a control circuit 3, and M number of drive circuit string(s) 51 each including N number of drive circuits (IC1 to ICN) that are connected in series, where M≥1. Accordingly, there are a total of M×N number of drive circuits (IC1 to ICN), which may be arranged in a matrix configuration. Hereinafter, only one drive circuit string 51 will be described in further detail for the sake of brevity. The LED groups 4 are respectively connected to and controlled by the N number of drive circuits (IC1 to ICN) of the drive circuit string 51 to emit light.

The control circuit 3 includes a power supply terminal 30 that is configured to supply an operating voltage (VCC), a control terminal 31 that is configured to output a command signal (CTRL), and a feedback terminal 32. The command signal (CTRL) may be in one of three packet formats, which include a packet format for address setting, a packet format for brightness control, and a packet format for a data fetch request.

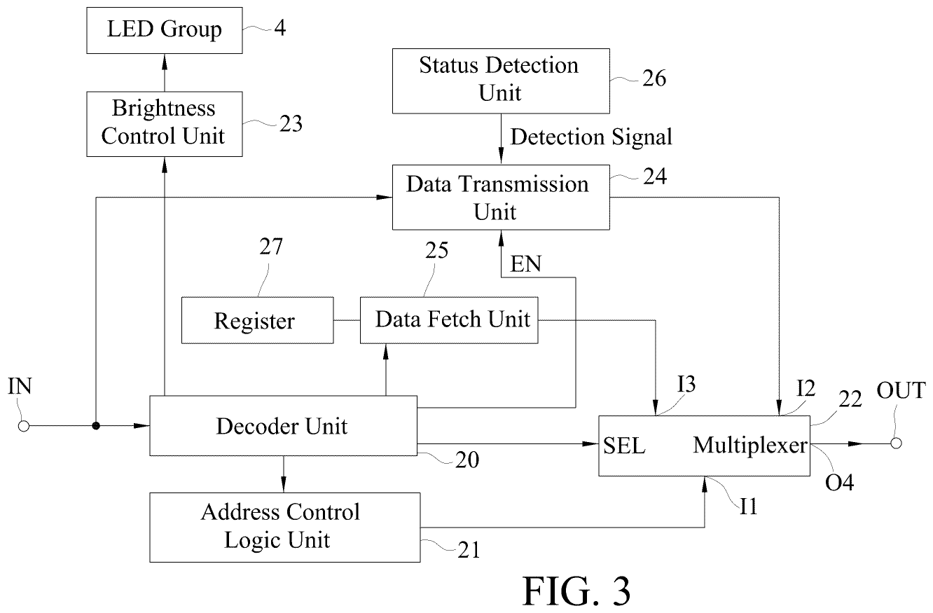

The drive circuit string 51 is electrically connected between the control terminal 31 and the feedback terminal 32 of the control circuit 3 via the common transmission line 2. Referring to FIG. 3, each of the N number of drive circuits (IC1 to ICN) includes an input terminal (IN), an output terminal (OUT), a decoder unit 20 that is electrically connected to the input terminal (IN), an address control logic unit 21 that is electrically connected to the decoder unit 20, a multiplexer 22 that is electrically connected to the decoder unit 20 and the output terminal (OUT), a data transmission unit 24 that is electrically connected to the input terminal (IN) and the multiplexer 22, a status detection unit 26 that is electrically connected to the data transmission unit 24, a brightness control unit 23 that is electrically connected to the decoder unit 20, a data fetch unit 25 that is electrically connected to the decoder unit 20 and the multiplexer 22, and a register 27 for storing data (e.g., brightness control settings).

Each of the drive circuits (IC1 to ICN) has a state setting operable to switch between a transmission state and a non-transmission state with respect to signal transmission between the input terminal (IN) and the output terminal (OUT) thereof. When the state setting is in the transmission state, a signal outputted by the output terminal (OUT) is received from and has content identical to content of a signal inputted into the input terminal (IN).

The input terminal (IN) of a first one of the drive circuits (IC1 to ICN) (hereinafter referred to as “a first drive circuit (IC1)”) is electrically connected to the control terminal 31 via the common transmission line 2. The input terminal (IN) of an i^{th} one of the drive circuits (IC1 to ICN) (hereinafter referred to as “i^{th} drive circuit”) is electrically connected to the output terminal (OUT) of an (i−1)^{th} one of the drive circuits (IC1 to ICN) (hereinafter referred to as “(i−1)^{th} drive circuit”), where 2≤i≤N. The output terminal (OUT) of the last one of the N number of drive circuits (IC1 to ICN) (hereinafter referred to as “an N^{th} drive circuit (ICN)”) is electrically connected to the feedback terminal 32 of the control circuit 3.

For each of the drive circuits (IC1 to ICN), the multiplexer 22 includes a first input terminal (I1), a second input terminal (I2), a third input terminal (I3), a select terminal (SEL) and a signal output terminal (O4) that is electrically connected to the output terminal (OUT). The multiplexer 22 is configured to select a signal from one of the first input terminal (I1), the second input terminal (I2), and the third input terminal (I3) to be transmitted to the signal output terminal (O4) based on a select signal received by the select terminal (SEL). The address control logic unit 21 is electrically connected in between the first input terminal (I1) of the multiplexer 22 and the decoder unit 20. The data transmission unit 24 is electrically connected to the decoder unit 20, the input terminal (IN) and the second input terminal (I2) of the multiplexer 22. The brightness control unit 23 is electrically connected to the decoder unit 20 and a respective one of the LED groups 4. The data fetch unit 25 is electrically connected to the register 27, the decoder unit 20 and the third input terminal (I3) of the multiplexer 22.

Operations of the drive circuit string 51 in response to the three packet formats of the command signal (CTRL) are described below.

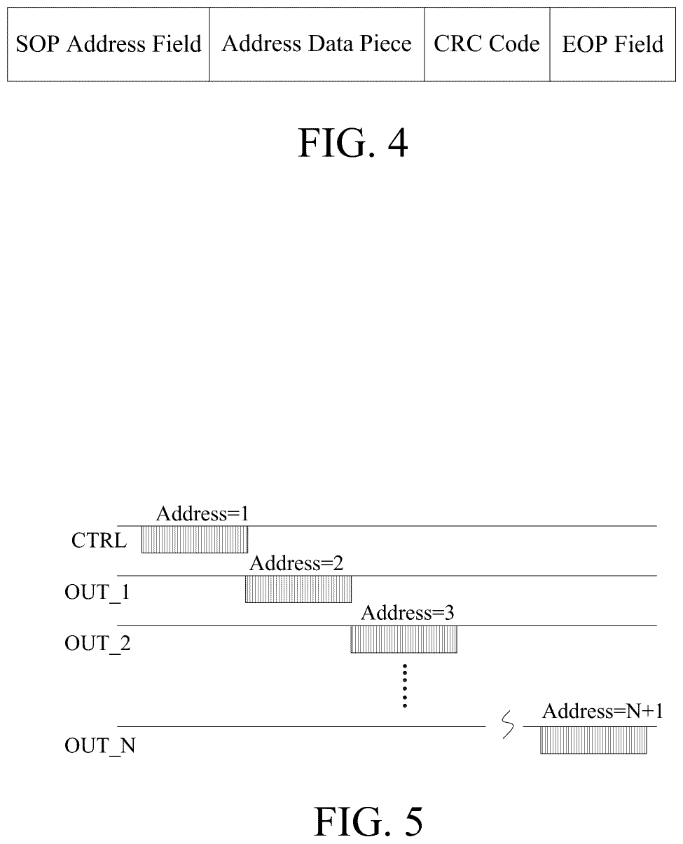

For an address setting operation, the control terminal 31 of the control circuit 3 transmits an address setting signal serving as the command signal (CTRL) to the input terminal (IN) of the first drive circuit (IC1) of the drive circuit string 51. The address setting signal includes an address setting data packet. The packet format of the address setting data packet is exemplarily shown in FIG. 4 and includes a Start of Packet (SOP) field for address setting (referred to as “SOP address field”) that indicates a start of an address-type data packet, an address data piece that indicates a preset starting address (such as address=1, but not limited to 1), a Cyclic Redundancy Check (CRC) code, and an End of Packet (EOP) field. In this embodiment, the drive circuits (IC1 to ICN) sequentially set an assigned address for each of the drive circuits (IC1 to ICN) based on the address setting signal. The assigned address for the first drive circuit (IC1) is equal to the preset starting address. The assigned address of the i^{th} drive circuit is equal to the preset starting address+(i−1).

When the decoder unit 20 of the first drive circuit (IC1) receives the address setting signal from the input terminal (IN) of the first drive circuit (IC1), the decoder unit 20 decodes the address setting signal, determines that the address setting signal includes the address setting data packet based on the SOP address field, and performs a CRC verification (at least to check the address data piece and the CRC code) on the address setting signal. If the CRC verification failed, the address setting operation ends; if the CRC verification is successful, the decoder unit 20 causes the multiplexer 22 to select a signal received from the address control logic unit 21 to be transmitted to the output terminal (OUT) of the first drive circuit (IC1). In specific, the decoder unit 20 generates and transmits a first select signal to the select terminal (SEL) of the multiplexer 22 for controlling the multiplexer 22 to select a signal from the first input terminal (I1) of the multiplexer 22 to be transmitted to the signal output terminal (O4) of the multiplexer 22, and transmits the address setting data packet that has been decoded to the address control logic unit 21.

The address control logic unit 21 of the first drive circuit (IC1) performs an automatic address setting operation to set the assigned address of the first drive circuit (IC1) based on the preset starting address, generates a setting address (e.g., by adding one to the assigned address of the first drive circuit (IC1)) for a second one of the drive circuits (IC1 to ICN) (hereinafter referred to as “a second drive circuit (IC2)”), packetizes the setting address for the second drive circuit (IC2) to generate a first serial address output signal, and transmits the first serial address output signal to the multiplexer 22 of the first drive circuits (IC1). In this embodiment, the preset starting address is 1. Therefore, the assigned address for the first drive circuit (IC1) is 1, and the setting address that is generated by the first drive circuit (IC1) is 1+1=2. The packet format of the first serial address output signal is identical to the packet format of the address setting data packet, except that a value of the address data piece of the first serial address output signal is 2. Since the decoder unit 20 has already transmitted the first select signal to the multiplexer 22 upon receiving the address setting signal, and has caused the multiplexer 22 to select the first serial address output signal received from the address control logic unit 21 to be transmitted to the output terminal (OUT) of the first drive circuit (IC1), the first serial address output signal is transmitted to the input terminal (IN) of the second drive circuit (IC2) through the output terminal (OUT) of the first drive circuit (IC1).

Referring to FIGS. 2 and 5, “CTRL” denotes a signal that is transmitted from the control circuit 3 to the input terminal (IN) of the first drive circuit (IC1), and “OUT_1”, “OUT_2” and “OUT_N” denote signals that are outputted by the first drive circuit (IC1), and the second drive circuit (IC2) to the N^{th} drive circuit (ICN), respectively. When the input terminal (IN) of the second drive circuit (IC2) receives the first serial address output signal (i.e., the signal “OUT_1” in FIG. 5) from the output terminal (OUT) of the first drive circuit (IC1), and the CRC verification performed on the first serial address output signal is successful, the address control logic unit 21 of the second drive circuit (IC2) performs the automatic address setting operation that is similar to that of the first drive circuit (IC1) setting the assigned address of the second drive circuit (IC2) based on the setting address of the first serial address output signal, to generate a setting address for a third one of the drive circuits (IC1 to ICN) (hereinafter referred to as “a third drive circuit (IC3)”), packetizes the setting address for the third drive circuit (IC3) to generate a second serial address output signal (i.e., the signal “OUT_2” in FIG. 5), and transmits the second serial address output signal to the multiplexer 22 of the second drive circuit (IC2) and subsequently to the input terminal (IN) of the third drive circuit (IC3). In the illustrative embodiment, the assigned address for the second drive circuit (IC2) is 2, and a setting address that is generated by the second drive circuit (IC2) is 2+1=3. The output terminal (OUT) of the (i−1)^{th} drive circuit transmits an (i−1)^{th} serial address output signal to the input terminal (IN) of the i^{th} drive circuit, where 2≤i≤N. The output terminal (OUT) of the last drive circuit (i.e., the N^{th} drive circuit (ICN)) transmits an N^{th} serial address output signal to the feedback terminal 32 of the control circuit 3. For example, if N=20, the last drive circuit (ICN) transmits a twentieth serial address output signal to the feedback terminal 32 of the control circuit 3. The address data piece that is transmitted by the output terminal (OUT) of the last drive circuit (ICN) to the feedback terminal 32 of the control circuit 3 is 20+1=21. The control circuit 3 determines that the address setting operation is completed when the feedback terminal 32 of the control circuit 3 receives the address data piece that is equal to 21, and performs the address setting operation from the beginning again when the feedback terminal 32 of the control circuit 3 did not receive a correct address data after a predetermined period of time has elapsed starting from the control circuit 3 outputting the address setting signal.

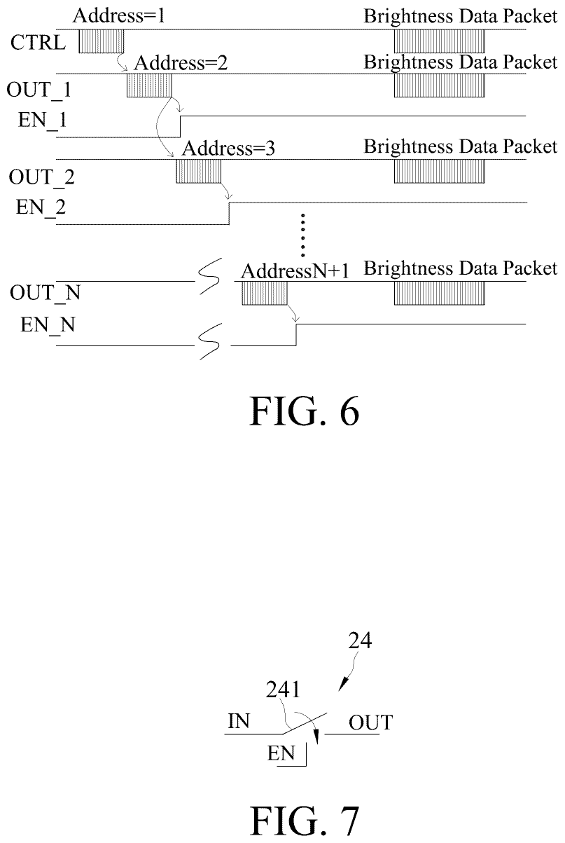

For each of the drive circuits (IC1 to ICN), when the setting of the assigned address of the drive circuit is completed, the state setting of the drive circuit is in the transmission state. Referring to FIGS. 2 and 6, “EN_1,” “EN_2” and “EN_N” denote enabling signals that are received by the data transmission unit 24 of the first drive circuit (IC1), the second drive circuit (IC2) and the N^{th} drive circuit (ICN), respectively. For example, when the first serial address output signal is sent out from the first drive circuit (IC1) to the second drive circuit (IC2), the decoder unit 20 of the first drive circuit (IC1) sends an enabling signal to the data transmission unit 24 of the first drive circuit (IC1), so that the data transmission unit 24 of the first drive circuit (IC1) permits signals to pass therethrough. Meanwhile, the decoder unit 20 controls the multiplexer 22 to permit signals received from the data transmission unit 24 to pass therethrough. In specific, the decoder unit 20 generates and transmits a second select signal to the select terminal (SEL) of the multiplexer 22 to control the multiplexer 22 to select a signal from the second input terminal (I2) of the multiplexer 22 to be transmitted to the signal output terminal (O4) of the multiplexer 22, so as to form a closed circuit between the input terminal (IN) and the output terminal (OUT). As a result, signals received by the input terminal (IN) are able to reach the output terminal (OUT) through the data transmission unit 24 and the multiplexer 22, thereby completing the switching of the first drive circuit (IC1) to the transmission state.

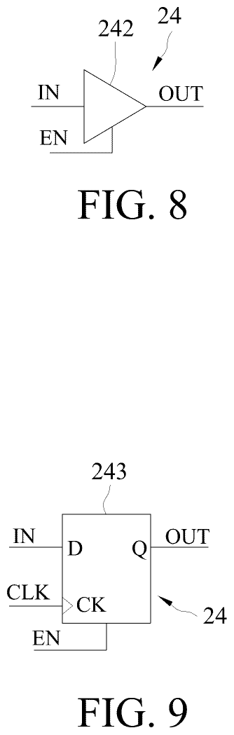

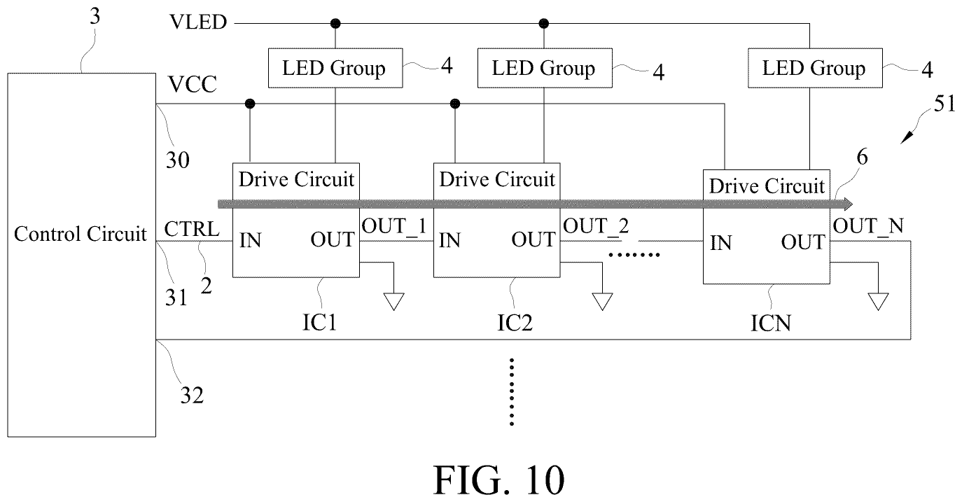

Referring to FIGS. 3 and 7, in one embodiment, the data transmission unit 24 includes a switch 241 (e.g., a transistor) that is electrically connected between the input terminal (IN) of the corresponding drive circuit (i.e., the drive circuit that includes the transmission unit 24) and the second input terminal (I2) of the multiplexer 22. The switch 241 is configured to form a closed circuit upon receiving the enabling signal, and to form an open circuit when not receiving the enabling signal. Referring to FIGS. 3 and 8, in one embodiment, the data transmission unit 24 includes a buffer 242 that is electrically connected between the input terminal (IN) of the corresponding drive circuit and the second input terminal (I2) of the multiplexer 22. Referring to FIGS. 3 and 9, in one embodiment, the data transmission unit 24 includes a flip-flop 243 that is electrically connected to the input terminal (IN) of the corresponding drive circuit and the second input terminal (I2) of the multiplexer 22. The flip-flop 243 includes a clock input, and a delay of signal transmission through the data transmission unit 24 is influenced by a clock period of the flip-flop 243 (e.g., proportional to the clock period). The data transmission unit 24 may also be just a short-circuited transmission line, which does not require the enabling signal, and the drive circuit may be operated to switch into the transmission state by just controlling the multiplexer 22. In specific, the drive circuit is operated to switch into the transmission state when the decoder unit 20 generates and transmits the second select signal to the multiplexer 22 to establish electrical connection between the second input terminal (I2) and the signal output terminal (O4), so the signal outputted at the output terminal (OUT) has content identical to content of the signal received at the input terminal (IN). Referring to FIG. 10, the N number of drive circuits (IC1 to ICN) form a pass-through signal transmission path 6 between the control terminal 31 and the feedback terminal 32 when the state setting of every single one of the N number of drive circuits (IC1 to ICN) is in the transmission state. If delay induced by internal components is not taken into consideration, a signal from the control terminal 31 of the control circuit 3 should be considered to have been transmitted to each of the drive circuits (IC1 to ICN) at the same time.

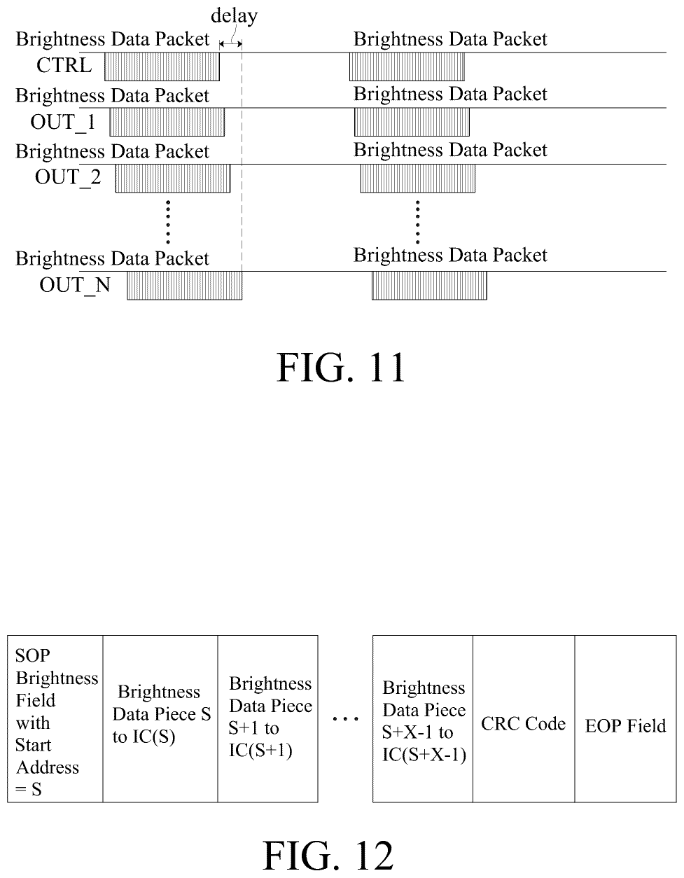

After the setting of the assigned address of each of the drive circuits (IC1 to ICN) is completed, every single one of the N number of drive circuits (IC1 to ICN) is in the transmission state, and the control circuit 3 performs a brightness control setting operation, where the control terminal 31 transmits the command signal (CTRL) that is a brightness control signal to each of the drive circuits (IC1 to ICN) via the common transmission line 2. Referring to FIG. 11, taking into consideration the delay induced by the internal components, the brightness control signal reaches the N number of drive circuits (IC1 to ICN) one after another. The brightness control signal includes a brightness data packet. The packet format of the brightness data packet is exemplarily shown in FIG. 12. The brightness data packet includes an SOP field for brightness control (referred to as SOP brightness field) that includes a start address(S), X number of brightness data piece(s), a CRC code, and an EOP field, where 1≤X≤N, the start address(S) corresponds to the assigned address of an S^{th} one of the N number of drive circuits (IC1 to ICN) to receive a first one of the brightness data piece(s), and the X number of brightness data piece(s) correspond respectively to X number of destination address(es) that is (are) target address(es) of brightness control from(S) to (S+X−1). In specific, the first one of the target addresses is the start address(S), which corresponds to the assigned address of the S^{th} one of the N number of drive circuits (IC1 to ICN); and the last one of the target addresses is (S+X−1), which corresponds to the assigned address of an (S+X−1)^{th} one of the N number of drive circuits (IC1 to ICN). Referring to FIGS. 3 and 10, the N number of drive circuits (IC1 to ICN) are configured in such a way that, based on the assigned addresses of the N number of drive circuits (IC1 to ICN), the decoder unit(s) 20 of X number of the N number of drive circuits (IC1 to ICN) of which the assigned address(es) respectively conform(s) with the target address(es) of brightness control read(s) the brightness data piece(s). In detail, the decoder unit 20 of each of the drive circuits (IC1 to ICN) decodes the brightness data packet, and when the assigned address of the corresponding drive circuit conforms with one of the target address(es) of brightness control, reads one of the brightness data piece(s) that corresponds to the one of the target address(es) of brightness control. Then, the decoder unit 20 sends the one of the brightness data piece(s) to the brightness control unit 23. The brightness control unit 23 generates a current based on the one of the brightness data piece(s), and sends the current to a respective one of the LED groups 4. In some embodiments, the control terminal 31 of the control circuit 3 may transmit brightness data pieces to the N number of drive circuits (IC1 to ICN) in multiple separate instances. For example, assuming that N=20, the control terminal 31 of the control circuit 3 may transmit, as a first instance, a brightness control signal that includes a brightness data packet containing the start address=1 and ten brightness data pieces, to each of the drive circuits (IC1 to IC20). The decoder unit 20 of each of the drive circuits (IC1 to IC20) decodes the brightness data packet, and only the first ten drive circuits (IC1 to IC10), starting from the drive circuit (IC1) with assigned address that conforms with the start address, will have the corresponding one of the brightness data pieces read by the decoder 20, and the decoder 20 of each of the drive circuits (IC1 to IC10) sends the brightness data piece thus read to the brightness control unit 23 when the CRC verification is successful. If the CRC verification is not successful, no brightness data piece(s) will be sent to the brightness control unit 23, and the brightness control unit 23 maintains use of the last brightness data piece received thereby to send a current correspondingly to a respective one of the LED groups 4. Then, the control terminal 31 of the control circuit 3 may transmit, as the second instance, a brightness control signal that includes a brightness data packet containing the start address=11 and ten brightness data pieces, to each of the drive circuits (IC1 to IC20). After the decoder unit 20 of each of the drive circuits (IC1 to IC20) decodes the brightness data packet, only in the last ten drive circuits (IC11 to IC20), starting with the drive circuit (IC11) with assigned address that conforms with the start address, which is now 11, will have the corresponding one of the brightness data pieces read by the decoder 20, and the decoder 20 of each of the drive circuits (IC11 to IC20) sends the brightness data piece thus read to the brightness control unit 23 when the CRC verification is successful. Then, the brightness control unit 23 of each of the drive circuits (IC1 to IC20) sends a current correspondingly to a respective one of the LED groups 4.

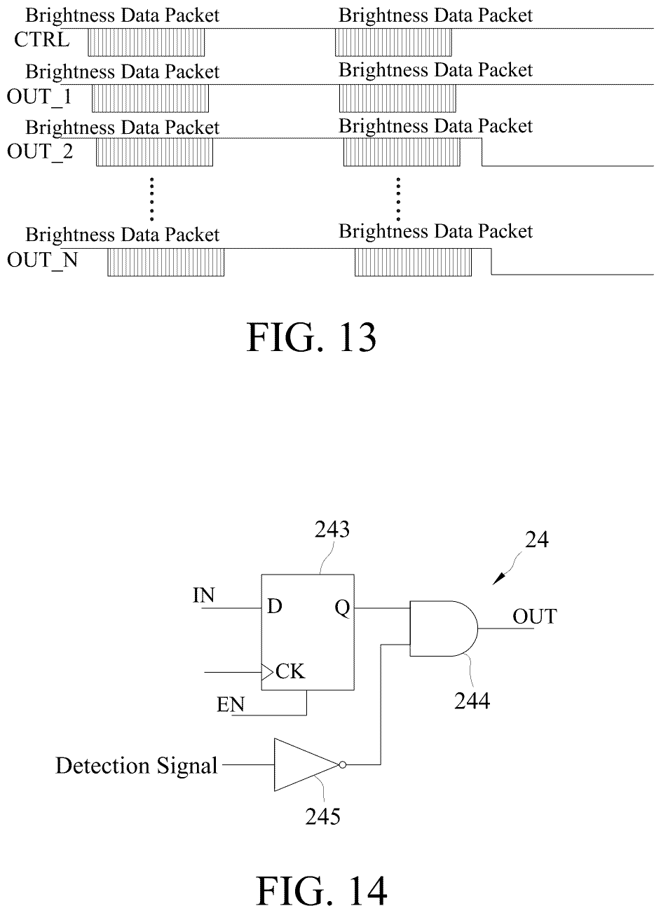

In this embodiment, a status detection and response operation may be performed when every single one of the N number of drive circuits (IC1 to ICN) is in the transmission state to form the pass-through signal transmission path 6. In the status detection and response operation, the status detection unit 26 of each of the drive circuits (IC1 to ICN) detects an internal situation of the drive circuit, generates a status response signal upon detecting an internal abnormal situation (e.g., overheating, which may be detected using a temperature sensor), and sends the status response signal to the control circuit 3 via the pass-through signal transmission path 6. Further referring to FIG. 13, an example of the status response signal where the second drive circuit (IC2) is having an overheating issue is shown. When the status detection unit 26 of the second drive circuit (IC2) detects the overheating issue, the status detection unit 26 generates and transmits a logic level 1 to the data transmission unit 24. The data transmission unit 24 then outputs a logic level 0 as the status response signal to the output terminal (OUT) of the second drive circuit (IC2). At this time, as the third drive circuit (IC3) to the N^{th} drive circuit (ICN) are still in the transmission state, the signals outputted by the output terminals (OUT) of the third drive circuit (IC3) to the N^{th} drive circuit (IC3) would be brought to logic level 0 one after another. Subsequently, the feedback terminal 32 of the control circuit 3 receives the signal of logic level 0 from the output terminal (OUT) of the N^{th} drive circuit (ICN). Referring to FIGS. 3 and 14, another variation of the data transmission unit 24 is shown. In this variation, the data transmission unit 24 includes a flip-flop 243 that is electrically connected to the input terminal (IN) of the corresponding drive circuit, an inverter (or NOT gate) 245 that is electrically connected to the status detection unit 26 for receiving a detection signal, and an AND gate 244 that is electrically connected to the flip-flop 243, the inverter 245, and the second input terminal (I2) of the multiplexer 22. When the detection signal from the status detection unit 26 is at logic level 1, the inverter 245 outputs logic 0, so a signal outputted by the AND gate 244 is of logic level 0. The signal of logic level 0 is subsequently transmitted to the second input terminal (I2) of the multiplexer 22 and then to the output terminal (OUT) of the corresponding drive circuit as the status response signal.

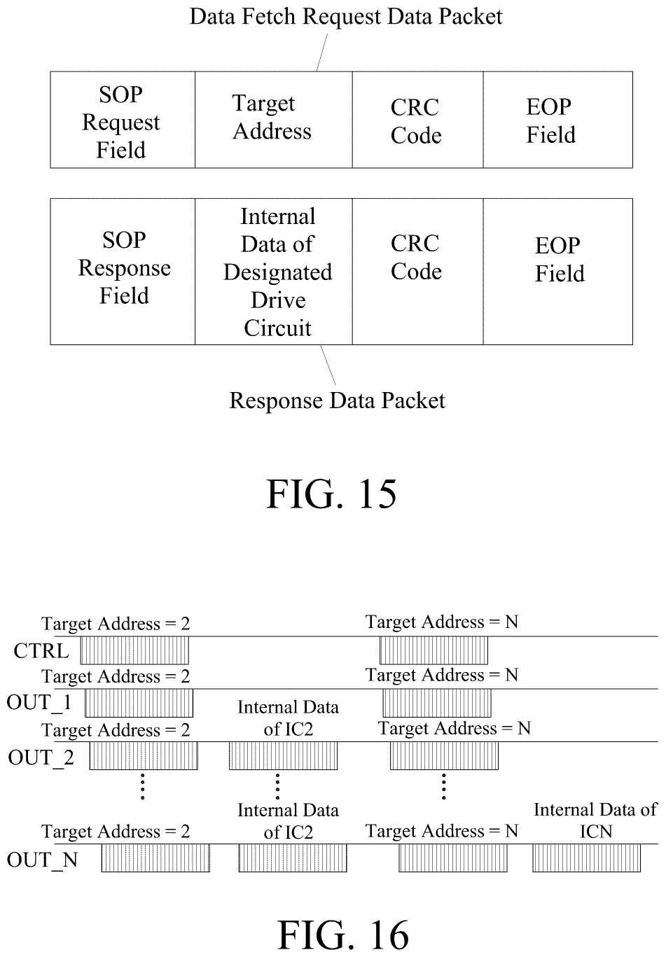

In this embodiment, a data fetch operation may be performed when every single one of the N number of drive circuits (IC1 to ICN) is in the transmission state to form the pass-through signal transmission path 6. In the data fetch operation, the control circuit 3 transmits the command signal (CTRL) that includes a data fetch request data packet to each of the drive circuits (IC1 to ICN) via the control terminal 31 and the pass-through signal transmission path 6, for acquiring internal data (e.g., a temperature, a voltage headroom, etc.) of one of the drive circuits (IC1 to ICN). Referring to FIG. 15, the data fetch request data packet includes an SOP field for data fetch request (referred to as SOP request field), the destination address that is a target address of data fetch, a CRC code and an EOP field, where the target address of data fetch is the assigned address of a designated one of the drive circuits (IC1 to ICN) from which the internal data is to be fetched. For each of the drive circuits (IC1 to ICN), when the drive circuit receives the data fetch request data packet and when the assigned address of the drive circuit conforms with the target address of data fetch, the data fetch unit 25 of the drive circuit generates and transmits a response data packet to the feedback terminal 32 via the pass-through signal transmission path 6. The response data packet includes an SOP field for response (referred to as “SOP response field”), the internal data of the designated one of the drive circuits (IC1 to ICN), a CRC code, and an EOP field.

In specific, when the control circuit 3 wants to fetch internal data from one of the drive circuits (IC1 to ICN), the control circuit 3 transmits the command signal (CTRL) that includes a data fetch request data packet to each of the drive circuits (IC1 to ICN) via the control terminal 31 and the pass-through signal transmission path 6. The decoder unit 20 of each of the drive circuit (IC1 to ICN) decodes the data fetch request data packet, and compares the assigned address of the corresponding drive circuit with the target address for the data fetch. When the comparison result shows that the assigned address of the corresponding drive circuit does not conform with the target address for the data fetch, the drive circuit does not proceed with further actions. When the comparison results shows that the assigned address of the corresponding drive circuit conforms with the target address for the data fetch, which means that the corresponding drive circuit is the designated one of the drive circuits (IC1 to ICN), the decoder unit 20 continues with CRC verification. If the CRC verification is successful, the decoder unit 20 transmits the data fetch request data packet that has been decoded to the data fetch unit 25. At the same time, the decoder unit 20 generates and transmits a third select signal to the multiplexer 22 of the designated one of the drive circuits (IC1 to ICN) to control the multiplexer 22 to select a signal from the third input terminal (I3) to be outputted to the signal output terminal (O4) of the multiplexer 22. The data fetch unit 25 upon receiving the data fetch request data packet, fetches the internal data (e.g., temperature data collected by temperature sensors, voltage headroom data collected by voltage comparators, etc.) from the register 27 of the designated one of the drive circuits (IC1 to ICN) based on the data fetch request data packet, and generates and transmits a response data packet that corresponds to the data fetch request data packet to the third input terminal (I3) of the multiplexer 22. The multiplexer 22 then transmits the response data packet to the signal output terminal (O4) of the multiplexer 22 and subsequently to the output terminal (OUT) of the designated one of the drive circuits (IC1 to ICN). The response data packet is then transmitted to the next one of the drive circuits (IC1 to ICN) and finally to the output terminal (OUT) of the last drive circuit (ICN) through the pass-through signal transmission path 6, so the control circuit 3 receives the response data packet from the feedback terminal 32.

Referring to FIGS. 10 and 16, it is exemplified that the control circuit 3 first transmits a data fetch request data packet with the target address of the data fetch being the assigned address of the second drive circuit (IC2) (i.e., target address of data fetch=2). When the second drive circuit (IC2) receives the data fetch request data packet and the CRC verification is successful, the second drive circuit (IC2) generates and transmits a response data packet and at the output terminal (OUT) thereof. As a result, the response data packet is transmitted to the N^{th} drive circuit (ICN) through the third drive circuit (IC3) to the (N−1)^{th} drive circuit in sequence, and thus reaches the feedback terminal 32 of the control circuit 3. Then, the control circuit 3 first transmits a data fetch request data packet with the target address of data fetch being the assigned address of the N^{th} drive circuit (ICN) (i.e., target address for data fetch=N). When the N^{th} drive circuit (ICN) receives the data fetch request data packet and the CRC verification is successful, the N^{th} drive circuit (ICN) generates and transmits a response data packet to the output terminal (OUT) of the N^{th} drive circuit (ICN) and subsequently to the feedback terminal 32 of the control circuit 3.

In sum, a control system for a light emitting device according to an embodiment of the present disclosure uses only one common transmission line 2 to sequentially transmit the address setting data packet and the brightness data packet to each of the N number of drive circuits (IC1 to ICN), so a number of wires needed to connect the control circuit 3 to the N number of drive circuits (IC1 to ICN) is effectively reduced compared to the prior art, thereby achieving a lower wiring complexity as well.

In addition, when the setting of the assigned address of an individual drive circuit is completed, the state setting of the drive circuit is in the transmission state where a signal outputted by the output terminal (OUT) of the drive circuit has content identical to content of a signal inputted into the input terminal (IN) of the drive circuit. As a result, when the state setting of every single one of the N number of drive circuits (IC1 to ICN) is in the transmission state, the pass-through signal transmission path 6 is formed between the control terminal 31 and the feedback terminal 32 of the control circuit 3. This not only enables the brightness data packet to be sent to each of the drive circuits (IC1 to ICN) almost simultaneously via the common transmission line 2, but also enables the internal abnormal situation of any drive circuit to be sent to the control circuit 3 quickly. Also, a failure in CRC verification of any one of the drive circuits (IC1 to ICN) will not cause subsequent drive circuits to be unable to update the brightness control setting. Furthermore, the internal data of the drive circuits (IC1 to ICN) may also be fetched easily and quickly through such configuration.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A control system for a light emitting device, comprising:
a control circuit including a control terminal;
a common transmission line; and
a drive circuit string electrically connected to said control terminal of said control circuit and including N number of drive circuits, where N≥2, each of said N number of drive circuits including an input terminal and an output terminal, said input terminal of a first one of said N number of drive circuits being electrically connected to said control terminal of said control circuit via said common transmission line, said input terminal of an i^{th} one of said N number of drive circuits being electrically connected to said output terminal of an (i−1)^{th} one of said N number of drive circuits, where 2≤i≤N,
wherein said control terminal of said control circuit is configured to transmit an address setting signal to said drive circuit string via said common transmission line, the address setting signal including a preset starting address;
wherein said N number of drive circuits are configured to sequentially set an assigned address for each of said N number of drive circuits based on the address setting signal;
wherein said control terminal of said control circuit is configured to, after the setting of the assigned address of each of said N number of drive circuits is completed, transmit a command signal to each of said N number of drive circuits via said common transmission line, the command signal including a data packet, the data packet including X number of data piece(s) that correspond respectively to X number of destination address(es), where 1≤X≤N; and
wherein said N number of drive circuits are configured in such a way that, based on the assigned addresses of said N number of drive circuits, among said N number of drive circuits, X number of drive circuit(s) of which the assigned address(es) respectively conform(s) with the destination address(es) read(s) the data piece(s).

2. The control system for a light emitting device as claimed in claim 1, wherein each of said N number of drive circuits has a state setting operable to switch between a transmission state and a non-transmission state with respect to signal transmission between said input terminal and said output terminal thereof; and
wherein, for each of said N number of drive circuits, when the setting of the assigned address of the drive circuit is completed, the state setting of said drive circuit is in the transmission state where a signal outputted by said output terminal of the drive circuit is received from said input terminal of said drive circuit, and has content identical to content of a signal inputted into said input terminal of said drive circuit.

3. The control system for a light emitting device as claimed in claim 2, wherein said control circuit further includes a feedback terminal electrically connected to a last one of said N number of drive circuits;
wherein said N number of drive circuits form a pass-through signal transmission path between said control terminal and said feedback terminal of said control circuit when the state setting of every single one of said N number of drive circuits is in the transmission state.

4. The control system for a light emitting device as claimed in claim 3, wherein each of said N number of drive circuits further includes a status detection unit configured to generate a status response signal upon detecting an internal abnormal situation, and to send the status response signal to said control circuit via the pass-through signal transmission path.

5. The control system for a light emitting device as claimed in claim 3, wherein said control circuit is configured to transmit the command signal to each of said N number of drive circuits via said control terminal and the pass-through signal transmission path, the command signal including the data packet that is a data fetch request data packet, the data fetch request data packet including the destination address that is a target address of data fetch and that is the assigned address of a designated one of said N number of drive circuits; and
wherein each of said N number of drive circuits is configured to, when said drive circuit receives the data fetch request data packet and when the assigned address of said drive circuit conforms with the target address of data fetch, generate and transmit a response data packet to said feedback terminal via the pass-through signal transmission path, the response data packet including internal data of the designated one of said N number of drive circuits.

6. The control system for a light emitting device as claimed in claim 1, wherein the first one of said N number of drive circuits includes a decoder unit electrically connected to said input terminal of the first one of said N number of drive circuits, an address control logic unit electrically connected to said decoder unit, and a multiplexer electrically connected to said decoder unit and said output terminal of the first one of said N number of drive circuits;
wherein said address control logic unit is configured to perform an automatic address setting operation to set the assigned address of the first one of said N number of drive circuits based on the preset starting address, to generate a setting address for a second one of said N number of drive circuits, to packetize the setting address for the second one of said N number of drive circuits to generate a first serial address output signal, and to transmit the first serial address output signal to said multiplexer; and
wherein said decoder unit is configured to, upon receiving the address setting signal from said control terminal, cause said multiplexer to select the first serial address output signal received from said address control logic unit to be transmitted to said output terminal of the first one of said N number of drive circuits.

7. The control system for a light emitting device as claimed in claim 6, wherein the first one of said N number of drive circuits further includes a data transmission unit electrically connected to said input terminal of the first one of said N number of drive circuits and said multiplexer;
wherein said decoder unit is configured to cause said multiplexer to select a signal received from said data transmission unit to be transmitted to said output terminal of the first one of said N number of drive circuits after the first serial address output signal is sent to the second one of said N number of drive circuits.

8. The control system for a light emitting device as claimed in claim 6, wherein the first one of said N number of drive circuits further includes a brightness control unit electrically connected to said decoder unit;
wherein the command signal is a brightness control signal including the data packet that is a brightness data packet, the brightness data packet including X number of brightness data piece(s) that correspond respectively to the X number of destination address(es) that is (are) the target address(es) of brightness control;
wherein said decoder unit is configured to decode the brightness data packet, and to, when the assigned address of the first one of said N number of drive circuits conforms with one of the target address(es) of brightness control, read one of the brightness data piece(s) that corresponds to said one of the target address(es) of brightness control conforming with the assigned address of said drive circuit, and to send said one of the brightness data piece(s) to said brightness control unit; and
wherein said brightness control unit is configured to generate a current based on said one of the brightness data piece(s), and to send the current to a light emitting diode group.

9. A light emitting device, comprising:
N number of light emitting diode (LED) groups; and
a control system including a control circuit and a drive circuit string,
said control circuit including a control terminal,
said drive circuit string being electrically connected to said control terminal of said control circuit and including N number of drive circuits, where N≥2, each of said N number of drive circuits including an input terminal and an output terminal, said input terminal of a first one of said N number of drive circuits being electrically connected to said control terminal, said input terminal of an i^{th} one of said N number of drive circuits being electrically connected to said output terminal of an (i−1)^{th} one of said N number of drive circuits, where 2≤i≤N,
wherein said control terminal of said control circuit is configured to transmit an address setting signal to said drive circuit string, the address setting signal including a preset starting address;
wherein said N number of drive circuits is configured to sequentially set an assigned address for each of said N number of drive circuits based on the address setting signal;
wherein each of said N number of drive circuits has a state setting operable to switch between a transmission state and a non-transmission state with respect to signal transmission between said input terminal and said output terminal thereof;
wherein, for each of said N number of drive circuits, when the setting of the assigned address of said drive circuit is completed, the state setting of said drive circuit is in the transmission state;
wherein said control terminal of said control circuit is configured to, after the setting of the assigned address of each of said N number of drive circuits is completed, transmit a command signal to each of said N number of drive circuits, the command signal including a data packet, the data packet including X number of data piece(s) that correspond respectively to X number of destination address(es), where 1≤X≤N;
wherein said N number of drive circuits are configured in such a way that, based on the assigned addresses of said N number of drive circuits, among said N number of drive circuits, X number of drive circuit(s) of which the assigned address(es) respectively conform(s) with the destination address(es) read(s) the data piece(s); and
wherein said N number of LED groups are respectively connected to and controlled by said N number of drive circuits to emit light.

10. The light emitting device as claimed in claim 9, wherein the command signal is a brightness control signal, the brightness control signal including the data packet that is a brightness data packet, the brightness data packet including X number of brightness data piece(s) that correspond respectively to the X number of destination address(es) that is (are) the target address(es) of brightness control.

11. The light emitting device as claimed in claim 10, wherein said X number of said N number of drive circuits are configured to generate and output, based on the brightness data piece(s), currents to corresponding one(s) of LED groups.

12. The light emitting device as claimed in claim 9, wherein when the state setting of said drive circuit is in the transmission state, a signal outputted by said output terminal of the drive circuit is received from said input terminal of said drive circuit, and has content identical to content of a signal inputted into said input terminal of said drive circuit.
